(19) United States
(12) Patent Application Publication
(10) Pub. No.: US 2017/0225582 A1
(43) Pub. Date: Aug. 10, 2017

(54) Method and Base Unit for Inductively Charging Electric and Hybrid Vehicles

(71) Applicant: Bayerische Motoren Werke Aktiengesellschaft, Muenchen (DE)

(72) Inventors: Alexander AUGST, Muenchen (DE); Peter VARADI, Vaterstetten (DE)

(21) Appl. No.: 15/581,242

(22) Filed: Apr. 28, 2017

Related U.S. Application Data
(63) Continuation of application No. PCT/EP2015/074025, filed on Oct. 16, 2015.

(30) Foreign Application Priority Data
Oct. 29, 2014 (DE) 10 2014 222 000.9

(51) Int. Cl. B60L 11/18; H02J 50/10

(52) U.S. Cl. CPC B60L 11/1831; B60L 11/182; B60L 11/1835; H02J 50/10

(57) ABSTRACT

A base unit is provided for a charging station for inductively charging an electrical store of a vehicle. The base unit has a primary coil, which is designed, if there is electromagnetic coupling to a secondary coil of the vehicle, to transmit electrical energy to the secondary coil. The base unit also has an image sensor, which is designed to capture image data of at least a part of the vehicle. In addition, the base unit has a control unit, which is designed to provide or use the image data for positioning the secondary coil in relation to the primary coil.

### CROSS REFERENCE TO RELATED APPLICATIONS

This application is a continuation of PCT International Application No. PCT/EP2015/074025, filed Oct. 16, 2015, which claims priority under 35 U.S.C. §119 from German Patent Application No. 10 2014 222 000.9, filed Oct. 29, 2014, the entire disclosures of which are herein expressly incorporated by reference.

### BACKGROUND AND SUMMARY OF THE INVENTION

The invention relates to a device and a corresponding method for inductively charging an at least partially electrically driven vehicle.

Vehicles with an electric drive typically have a battery, in which electrical energy for operating an electric motor of the vehicle can be stored. The battery of the vehicle can be charged with electrical energy from a power supply system. For this purpose, the battery is coupled to the power supply system in order to transfer the electrical energy from the power supply system into the battery of the vehicle. The coupling may take place in a wire-bound manner (by way of a charging cable) and/or a wireless manner (on the basis of an inductive coupling between a charging station and the vehicle).

One way that is used for the automatic, cableless, inductive charging of the battery of the vehicle is that the electrical energy is transferred to the battery by way of magnetic induction from the ground to the underfloor of the vehicle over the underfloor clearance 120. This is shown by way of example in FIG. 1. In particular, FIG. 1 shows a vehicle 100 with an energy store 103 for electrical energy (for example with a rechargeable battery 103). The vehicle 100 has a so-called secondary coil in the vehicle underfloor, the secondary coil being connected to the energy store 103 by way of an impedance matching (not shown) and a rectifier 101. The secondary coil is typically part of a so-called “Wireless Power Transfer” (WPT) vehicle unit 102.

The secondary coil of the WPT vehicle unit 102 may be positioned over a primary coil, the primary coil being fitted for example on the floor of a garage. The primary coil is typically part of a so-called WPT base unit 111. The primary coil is connected to a power supply 110 (in this document also referred to as the charging unit 110). The power supply 110 may include a radio-frequency generator, which generates an AC current (alternating current) in the primary coil of the WPT base unit 111, whereby a magnetic field is induced. This magnetic field is also referred to in this document as the electromagnetic charging field. The electromagnetic charging field may have a predefined charging field frequency range. The charging field frequency range may lie in the LF (low-frequency) range, for example at 80-90 kHz (in particular at 85 kHz).

With sufficient magnetic coupling between the primary coil of the WPT base unit 111 and the secondary coil of the WPT vehicle unit 102 over the underfloor clearance 120, a corresponding voltage, and consequently also a current, is induced in the secondary coil by the magnetic field. The induced current in the secondary coil of the WPT vehicle unit 102 is rectified by the rectifier 101 and stored in the energy store 103 (for example in the battery). Thus, electrical energy can be transferred in a wireless manner from the power supply 110 to the energy store 103 of the vehicle 100. The charging operation may be controlled in the vehicle 100 by a charging controller 105 (also referred to as the WPT controller 105). For this purpose, the charging controller 105 may be designed to communicate, for example wirelessly, with the charging unit 110 (for example with a wall box) or with the WPT base unit 111.

To provide a sufficient magnetic coupling between the primary coil in the WPT base unit 111 and the secondary coil in the WPT vehicle unit 102, a precise positioning of the coils in relation to one another is required. This may lead to time-intensive maneuvering operations, in which the vehicle 100 is aligned over the WPT base unit 111 in a number of maneuvering operations. In this process, the driver must remain in the car and/or, in the case of an automatic vehicle movement, be ready at any time to intervene in the automatic vehicle movement (“driver in the loop” requirement). Furthermore, for an automatic vehicle movement for a maneuvering operation, a laborious development of a sensor system and a vehicle assistance function with high functional reliability (ASIL methodology) is often required. Furthermore, typically suitable boundary conditions must be created in the vehicle (architecture, etc.), in order to provide such an automated maneuvering function. This may lead to relatively long development times and relatively great expenditures on safety arrangements, test equipment in the dealership network, etc. Furthermore, with such automatic vehicle functions it is often necessary to meet high approval requirements, which can lead to restrictions on the ability to obtain approval.

The present document is concerned with the technical object of making it possible for the primary coil and the secondary coil to be positioned for the inductive charging of a vehicle in a manner that is simplified for the user, and is possibly automatic.

This and other objects are achieved according to one aspect of the invention by a method for positioning a primary coil under a secondary coil of a vehicle. The method comprises the changing of a position of the primary coil to make electromagnetic coupling possible between the primary coil and the secondary coil for the inductive charging of an electrical (energy) store of the vehicle. Changing the position may in this case comprise, for example, the following movement components: displacement in the X direction, in the Y direction and/or the Z direction in the system of coordinates of the vehicle and/or rotation of the primary coil, in particular up to an angle of +/−about 5°-15°, and/or a pitching and/or tilting of the primary coil. Preferably, the electromagnetic coupling is in this case increased until a coupling measure is greater than a predefined threshold. Particularly preferably, the electromagnetic coupling is in this case optimized in such a way that substantially a maximum is reached, preferably the global maximum of a function that describes a dependence of the electromagnetic coupling on the relative position of the primary coil in relation to the secondary coil.

The primary coil may be moved by a movement device and the changing of the position of the primary coil may comprise initiating the movement device to move the primary coil in order to bring about an electromagnetic coupling between the primary coil and the secondary coil.

The method may further comprise the determining of one or more positioning signals, the one or more positioning signals comprising items of information concerning how the primary coil is positioned in relation to the secondary coil. Furthermore, the method may comprise the changing of the position of the primary coil in dependence on the one or more positioning signals. Preferably, these positioning signals may represent a relative position of the primary coil in relation to the secondary coil. A relative position may also comprise one or more vector quantities, which represent the difference between an actual position and a setpoint position or represent the difference between the spatial positions of the respective coil faces. Positioning signals may also represent specific quantitative information relating to the deviations from an optimum (relative) position and/or a specific movement requirement, which comprise for example one or more movement vectors or specifications for performing a (relative) movement. Particularly preferably, positioning signals may comprise at least two, preferably three, geometrical parameters that are mathematically orthogonal to one another. Such parameters may comprise for example positions in the X direction, Y direction, Z direction of an orthogonal (Cartesian) system of coordinates or analogous mathematically independent parameters, for example in a system of spherical polar coordinates, or in a special system of coordinates. In this case, the operation of changing the position may comprise an optimized two- or three-dimensional alignment of the primary coil and the secondary coil in relation to one another. This allows the electromagnetic coupling to be optimized, which with an ever increasing amount of energy brings about smaller energy losses, and possibly less electromagnetic emission (radiation) to the outside.

The primary coil may be arranged in a base unit. The one or more positioning signals may comprise sensor data (in particular image data) from a sensor that is connected to the base unit. The connection to the base unit in this case implies typically at least one predetermined position of the sensor in relation to an immovable or movable part of the base unit. The connection may be in particular a fixed (reversible or non-reversible) physical connection. The sensor data may comprise items of information relating to the position of at least part of the vehicle (for example items of information with respect to the underfloor of the vehicle). The sensor may be connected to the primary coil, and consequently typically be even more suitable for measuring the relative position. Alternatively, the sensor may be moved in a way dependent on the movement of the primary coil. The sensor may consequently be connected to the primary coil, or may be movably designed or move in dependence on the movement of the primary coil, for example by a mechanical or mechatronic device. Such a movement may also take place on a special straight or curved rail or guide.

The sensor may preferably be an image sensor and/or a light-emitting or light-sensing sensor, for example an LED sensor or a laser sensor. An image sensor may in this case be designed as a camera, which senses the light in the visible or invisible spectral range. The sensor may comprise a corresponding computing unit, for example an image processing unit for providing or evaluating the sensor data, for example image data, object data, point cloud data, edge data or coordinate data. A sensing of the position of the secondary coil with a sensor that is in particular connected to the base unit offers various advantages in comparison with a conceivable positioning operation (solely) by means of a sensor that is fitted on the vehicle. A sensor according to the invention is in particular not exposed to the environmental influences and stresses in the same way as for example a corresponding sensor on the vehicle floor.

The method may further comprise the evaluating of the sensor data, in order to determine a position of the primary coil in relation to the secondary coil, in particular by use of image processing, object recognition and/or pattern recognition. In the case of sensors that use other functional principles, a corresponding processing of sensor data, in particular on the basis of a recognition of certain patterns in the sensor data, filtering of the data, etc., may be applied.

The method may also comprise manual or partially automated teaching, in particular once per vehicle or regularly. During the teaching, a positioning operation takes place with the aid of further measures, learning data being determined in dependence on this positioning operation and used (after intermediate storage) in one or more subsequent performances of the method.

Further measures that are used during the teaching may in this case be devices for positioning that is partially controlled by a person and/or connecting or using a further measuring device or computing unit or the running of a computer program product designed for this.

The learning data may be used for a (simplified, more precise, quicker) performance of the method. For example, these data may be used for instance in determining the positioning signals when finding an optimized relative position. Such learning data may represent calibrating data and/or special properties of the vehicle or of the charging station or of the environment and/or of the sensor.

Positioning signals, preferably comprising the relative position of the primary coil and the secondary coil, may be determined in this case, in dependence on a known or taught or determined geometrical relationship of the part of the vehicle to the secondary coil.

As an alternative or in addition, the method may also comprise the inputting, wireless transmitting or determining of the learning data. For example, the learning data that have been determined in connection with one vehicle may be used in the case of another vehicle (of the same or a different type), and/or learning data that have been determined when performing the method with one base unit may be used when performing the method with a different base unit.

The sensor, preferably an image sensor, may be designed for detecting predetermined, preferably distinctive, parts of the vehicle. Parts that are to be regarded as distinctive in this case are parts that can be sensed particularly well with the sensor and/or detected as such, or measured. In particular, predetermined parts may be detected on the basis of an increased degree of coincidence or increased correlation with a predetermined pattern in the sensor data. Preferably, such parts may be: part of the secondary coil, and/or part of the vehicle tires, and/or part of the vehicle axles.

In this case, the sensing or detecting of a number of parts of the vehicle may be used for checking the mutual plausibility of individual detections or for resolving unforeseen positioning situations. The image sensor may therefore be designed for detecting at least two or more parts of the vehicle and for determining the position and/or the angle in relation to at least two or more of the parts detected. Preferably, a method that is for example based on a (stereometric) triangulation may also be used, a method which leads to the determining of a relative position and/or of positioning signals that comprise three-dimensional data or movement data with two or three spatial components.

The method may comprise the generating of a (predetermined) light pattern and/or of light pulses, in particular of a (predetermined) sequence of light pulses and the sensing of sensor data with respect to the sequence of light pulses. The light patterns or light pulses may preferably be generated at least partially in the infrared range. The time intervals in which light patterns and/or light pulses or a (predetermined) sequence of light pulses are generated may be synchronized with time intervals of the sensing of the sensor data.

The sensor data sensed in dependence on light patterns, light pulses or on the sequences of light patterns and/or light pulses in this case offer a particular advantage over a sensing of for example customary (photographic) image data with a very weak or irregular light under the floor of the vehicle. Particularly a vehicle underfloor is typically a highly contaminated environment. This can offer reliable sensing of the parts of the vehicle on the basis of light patterns, light pulses or sequences of light patterns and/or light pulses (also especially in the infrared range). Preferably, the sensor data are in this case processed by means of a pattern recognition. This allows the method to be performed in an extremely robust, or trouble-free and precise manner.

The one or more positioning signals may comprise second sensor data, in particular image data from a second sensor, in particular an image sensor, that is arranged on the vehicle. The second image data may comprise items of information with respect to the primary coil.

The method may comprise the emitting of an electromagnetic and/or acoustic signal from an underfloor of the vehicle in the direction of the ground, and also the sensing of a reflection of the emitted signal. The one or more positioning signals may depend on the sensed reflection of the emitted signal. The emitted electromagnetic signal may comprise an optical signal, it being possible for most of its radiant energy to be in the visible or nonvisible spectrum. An acoustic signal may preferably be an ultrasound signal. Particularly preferably, the electromagnetic and/or acoustic signal comprises a certain pattern, for example image pattern, amplitude modulation pattern, and/or phase modulation pattern.

The sensor connected to the base unit may be designed for sensing a machine-readable code (for example a QR, quick response, code). Such a code may be sensed for example by an image sensor or by a laser scanner. An item of information that represents a technical parameter of the vehicle, in particular with respect to the secondary coil or the energy store of the vehicle, may be determined in dependence on the read-out data of a machine-readable code, for example from the underfloor of the vehicle by means of the sensor. The positioning signals and/or the charging operation of the vehicle may be operated in dependence on the sensed information. Such a method is advantageous particularly for charging stations that serve a large number of different vehicles, for example public charging stations, which may be fitted in parking garages, parking lots, shopping malls, etc. This allows these charging stations to be adapted automatically to a large number of different (in each case optimum) charging operations and standards. The machine-readable code may be a QR (quick response) code. This may be provided by a vehicle manufacturer, service or the driver him/herself on a certain part of the vehicle (in particular the secondary coil). Particularly preferably, the code may reflect a pattern, for example a contrast pattern in the infrared range. A code for the reflection of a certain light pattern in the infrared light range is advantageous. The pattern may also comprise redundant information or check numbers, in such a way that, when there is great contamination of part of the pattern, a detection is still possible on the basis of a sensed part of the pattern. Such a pattern can consequently be detected even when the machine-readable code is contaminated.

The machine-readable code may comprise one or more of the following data: one or more optimized charging curves (current/time), and/or one or more items of frequency information relating to the charging operation, and/or an item of information relating to the position of the secondary coil within the vehicle underfloor, one or more geometrical parameters relating to the arrangement of the secondary coil within the vehicle, in particular in relation to the machine-readable code, etc. In this case, the positioning signals with respect to the secondary coil may also be determined for example by sensing the position of the machine-readable code (easily detectable for the sensor) and of the read-out information.

As an alternative or in addition, the items of information relating to the optimized charging curves (current/time), and/or one or more items of frequency information relating to the charging operation, and/or an item of information relating to the position of the secondary coil may be transmitted in connection with the method within the vehicle underfloor, also by means of wireless communication, for example NFC (near field communication), WLAN, Bluetooth, etc. In this case, optimized charging operation of the vehicle can be determined, for example also in dependence on an available charging time, a distance still to be driven, for example from data of a navigation system. In this case, bidirectional communication between the vehicle and the base unit may also be performed.

The one or more positioning signals may comprise a feedback signal from the vehicle. In this case, the feedback signal may be generated by means of a vehicle system and/or by means of a device which is additionally provided for the purpose and is connected to the vehicle. The corresponding vehicle system and/or the device may in this case be designed for the sending of a feedback signal and/or for the receiving of at least one positioning signal.

The method may further comprise the determining of a positioning measure or a positioning quality and/or a coupling measure on the basis of one or more positioning signals. In this case, the positioning quality indicates a quality of the alignment between the primary coil and the secondary coil. The coupling measure indicates a quality of the electromagnetic coupling between the primary coil and the secondary coil. The changing of the position of the primary coil may take place in such a way that the positioning quality and/or the coupling measure are improved.

The position of the primary coil and/or the performance of a relative movement between the primary coil and the secondary coil and/or the determining of the one or more positioning signals may be dependent on the current charging status of the vehicle. For example, in the case of a first charging status, which represents a high charging requirement (for example >50%, >70%, or >80%), positioning signals with a first low tolerance threshold may be generated and/or implemented. For example, in the case of a second charging status, which represents a low charging requirement (for example <50%, <30%, or <20%), positioning signals with a second tolerance threshold may be generated and/or implemented. Particularly, the optimization of a geometrical position and/or a coupling measure may take place in dependence on how much energy is likely to be transferred in the charging operation.

An alignment of the movement of the primary coil and/or of the secondary coil may possibly also be performed during the charging operation. A renewed optimization of the electromagnetic coupling may take place in dependence on the changing of the charging current. A changing of the geometrical relative position may take place in dependence on the elapsed time and/or in dependence on an original charging status of the vehicle. Depending on the charging current, there are typically certain different optima for a geometrical alignment between the coils. The transferred charging current may be 5-50 times greater at the beginning of a charging operation than at the end of the charging operation. In particular during the movement of the primary coil, it may be advantageous to adapt the position of the primary coil to achieve a new optimum. Such a corrective movement may be performed for example after completion of ⅓, ⅔, and/or 3/3 of the charging operation.

The method may further comprise the sending of items of information with respect to the changing of the position of the primary coil by way of a wireless network to a user of the vehicle. A user can in this way be informed about the positioning operation.

The method may comprise the determining of an overall movement for a positioning of the primary coil in relation to the secondary coil. The overall movement may be divided into a first movement component and into a second movement component. The position of the primary coil may be changed in dependence on the first movement component. The position of the secondary coil may be changed in dependence on the second movement component. This is preferably a precalculated movement that leads to the achievement of an optimum coupling measure or a coupling measure higher than a predetermined threshold. Particularly preferably, the second movement component is also performed by means of the activation of the chassis height of the vehicle, in particular by activating the actuators of the shock absorber, pneumatic suspension, etc.

The method may further comprise the determining of a control signal, the control signal depending on an input at an input unit (for example at a so-called human-machine interface) of an electronic user device. The position of the primary coil may take place in dependence on the control signal. The electronic user device is preferably a mobile device, preferably a cell phone, smartphone, notebook, ultrabook, etc. The user device may also be part of so-called smart clothes. Smart clothes (intelligent clothes/wearables, also known as I wear) should be understood as meaning items of clothing that are equipped with electronic devices or functions. In particular, the electronic part and/or the sensory part of the smart clothes are in this case typically integrated in the item of clothing in such a way that they are not visible from the outside. The electronic components of smart clothes that are functionally used for performing the method may also be designed to be flexible and adaptable to the body form or body movement or physique.

The method may further comprise initiating that display information that represents a position of the primary coil is output by way of an output unit, for example a screen of the electronic user device. In this case, the displayed position may preferably be a relative position. Instead of a position, recommendations for movements and/or the requirement for correction relating to a movement that has already been performed and/or is planned by an automatic method may also be output. The method may comprise initiating that display information that represents a recommendation for action and/or a requirement for correction relating to the movement of the vehicle and/or of the coil is output by way of the output unit of the electronic user device.

Particularly preferably, the items of display information also comprise further items of information relating to the charging operation: such as for example a charging status determined or received from the vehicle, and/or specific driving instructions for the driver of the vehicle to achieve the optimum coupling measure (such as for example steering instruction, steering direction, gas pedal, braking), and/or recommended times and/or sequence of driving actions. Particularly preferably, the items of display information also comprise operator control elements with which a positioning operation and/or charging operation can be controlled or influenced, for example adapted.

Preferably, items of display information comprise a number of graphically displayed items of information, in particular symbols, status bars or displays relating to the positioning and/or relating to the charging operation. The display information may be at least partially “synthetic”, i.e. computer-generated, graphic information, which is displayed on the basis of determined values relating to the positioning operation and/or charging operation. Particularly preferably, the display information comprises a symbolically displayed relative position of the primary coil and the secondary coil in relation to one another. Furthermore, the display information may also comprise part of actual images based on sensor data. Most particularly preferably, the display information may represent an augmentation of information generated during the method (for example recommendations for action), for example in a symbolic form in an actual image, which is generated from sensor data, in particular image data.

According to a further aspect, a base unit for a charging station for inductively charging an electrical store of a vehicle is described. The base unit comprises a primary coil, which is designed to transfer electrical energy to a secondary coil of the vehicle when there is an electromagnetic coupling with the secondary coil. Furthermore, the base unit comprises movement devices, which are designed to move the primary coil in order to bring about an electromagnetic coupling between the primary coil and the secondary coil.

The charging station may also comprise a device which serves for at least approximate positioning of the vehicle over the base unit. The device may comprise one or more physical demarcations, for example channels or elevations on the floor.

The base unit may comprise a frame, in particular an angular or rounded frame. The movement means may comprise one or more rails, which are connected to the frame. Furthermore, the movement means may comprise actuators, which are designed to move the primary coil along the one or more rails. Alternatively or additionally, the movement devices may comprise rotation devices, which are designed to rotate the primary coil about a vertical axis of the primary coil. Alternatively or additionally, the movement devices may comprise one or more wheels and/or rollers, which are designed to move the primary coil.

The base unit may comprise a sensor, in particular an image sensor. The sensor may be designed to sense sensor data, in particular image data, of an underfloor of the vehicle from below, in particular obliquely from below.

The base unit may comprise lighting devices, which are designed to generate one or more light pulses or a predetermined sequence of light pulses. The sensor, in particular image sensor, may be designed to sense a reflection of the light pulse on the underfloor of the vehicle.

The base unit may comprise a control unit which is designed to perform one or more features of the method described in this document.

According to a further aspect, an electronic device for monitoring a positioning operation of a primary coil under a secondary coil of a vehicle is described. The electronic device comprises an output unit, which is designed to output items of display information with respect to a position of the primary coil and with respect to a position of the secondary coil of the vehicle. Furthermore, the device comprises an input unit, which is designed to sense an input of a user of the electronic device. The device also comprises a communication unit, which is designed to send a control signal in dependence on the sensed input in order to bring about a movement of the primary coil and/or of the secondary coil.

According to a further aspect, a base unit for a charging station for inductively charging an electrical store of a vehicle is described. The base unit may comprise any desired features of those described in this document. The base unit comprises a primary coil, which is designed to transfer electrical energy to a secondary coil of the vehicle when there is an electromagnetic coupling with the secondary coil. The base unit further comprises an image sensor, which is designed to sense image data from at least a part of the vehicle (in particular an underfloor of the vehicle). The base unit also comprises a control unit, which is designed to provide or use the image data for a positioning of the secondary coil in relation to the primary coil.

According to a further aspect, a method for positioning a primary coil of a base unit in relation to a secondary coil of a vehicle is described. The method comprises the determining of sensor data by a sensor of the base unit, the image data comprising items of information relating to the position of at least a part of the vehicle. The method also comprises the changing of the position of the primary coil and/or of the secondary coil in dependence on the sensor data.

According to a further aspect, a method for positioning a secondary coil of a vehicle in relation to a primary coil of a base unit of a charging station is described. The position of the secondary coil of the vehicle can be changed by an activation of an actuator of the vehicle. The actuator of the vehicle may be in particular an actuator of the chassis of the vehicle. The actuator may comprise for example a drive motor, a steering motor and/or a vertical-dynamic actuator of the chassis of the vehicle, for example for changing the chassis height, the pitch angle or roll angle of the chassis of the vehicle, etc.

The features described in this document may also be used in combination with this method. The method comprises in particular the determining of positioning signals from sensor data of a sensor (in particular an image sensor) that is connected to the base unit. The method further comprises the transmitting of the positioning signals to the vehicle. The transmitting of the positioning signals may in this case take place directly or indirectly, for example by way of a network, or by way of an electronic user device. The method also comprises the activating of the actuator of the vehicle in dependence on the transmitted positioning signals in order to bring about an electromagnetic coupling between the primary coil and the secondary coil for inductively charging an electrical store of the vehicle.

According to a further aspect, a vehicle (for example a passenger car, a truck or a motorcycle or power-assisted bicycle) is described, comprising an electrical store for storing electrical energy; a secondary coil for receiving electrical energy from a primary coil positioned under an underfloor of the vehicle; and a control unit, which is designed to perform one of the methods described in this document.

According to a further aspect, a computer program product is described. The computer program product may be designed to be run on a processor (for example on a control unit) and thereby perform one of the methods described in this document.

It should be noted that the methods, devices and systems described in this document can be used both alone and in combination with other methods, devices and systems described in this document. Furthermore, any aspects of the methods, devices and systems described in this document may be combined with one another in various ways. In particular, the features of the claims may be combined with one another in various ways.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic diagram of exemplary components of an inductive charging system.

FIGS. 2A and 2B show the structure of WPT base units given by way of example.

FIG. 3 shows an exemplary electronic device for controlling the positioning of the WPT base unit and/or the vehicle.

FIG. 4 shows an exemplary system for positioning the coils for an inductive charging operation.

### DETAILED DESCRIPTION OF THE DRAWINGS

As explained at the beginning, the present document is concerned with methods and devices for positioning the primary coil of a WPT base unit 111 in relation to the secondary coil of a WPT vehicle unit 102 in order to achieve a relatively great magnetic coupling between the primary coil and the secondary coil that is optimized in accordance with the boundary conditions (possibly the maximum possible coupling), and thus achieve a high efficiency of an inductive charging operation.

The aim here is to make it possible for the driver of a vehicle 100 to park his/her vehicle 100 in the vicinity of an inductive charging station 110, 111 (i.e. in particular in the vicinity of a WPT base unit 111) (for example in a garage or within a public charging location). The occupants of the vehicle 100 can then immediately get out and leave the vehicle 100. An exact positioning of the vehicle 100 in relation to the WPT base unit 111 by the driver is not required. In particular, the driver of the vehicle 100 does not have to wait in the vehicle 100 until the vehicle 100 has automatically maneuvered itself over the charging unit (i.e. over the WPT base unit 111).

On the other hand, the charging station 110, 111 is designed to adapt itself automatically to the position of the secondary coil. It is not required here that the driver of the vehicle 100 waits for the end of the positioning operation. After automatic positioning of the WPT base unit 111 under the WPT vehicle unit 102 (which can take about 10-30 seconds), the charging operation can be started automatically.

Also provided may be a device by which a remote-controlled positioning between the vehicle 100 and the base unit 111 can take place. In particular, a manual, remote-controlled positioning can take place by way of a software application on a personal electronic device (for example on a smartphone) of the driver of the vehicle 100. For example, if positioning difficulties occur (for example if the vehicle is positioned at a slant with respect to the base unit 111), the driver can obtain a corresponding message (for example SMS, MMS, email, etc.) by way of a wireless network (for example GMS, UMTS, LTE, WLAN). The driver can in this way be notified that manual positioning is required. The driver can then carry out remote-controlled positioning between the vehicle 100 and the base unit 111 by way of the device described in this document.

The positioning between the vehicle 100 and the base unit 111 by movement of the base unit 111 and/or by use of a remote control may take place as an alternative or in addition to an automatic positioning of the vehicle 100 over the inductive charging coil (i.e. over the primary coil of the base unit 111).

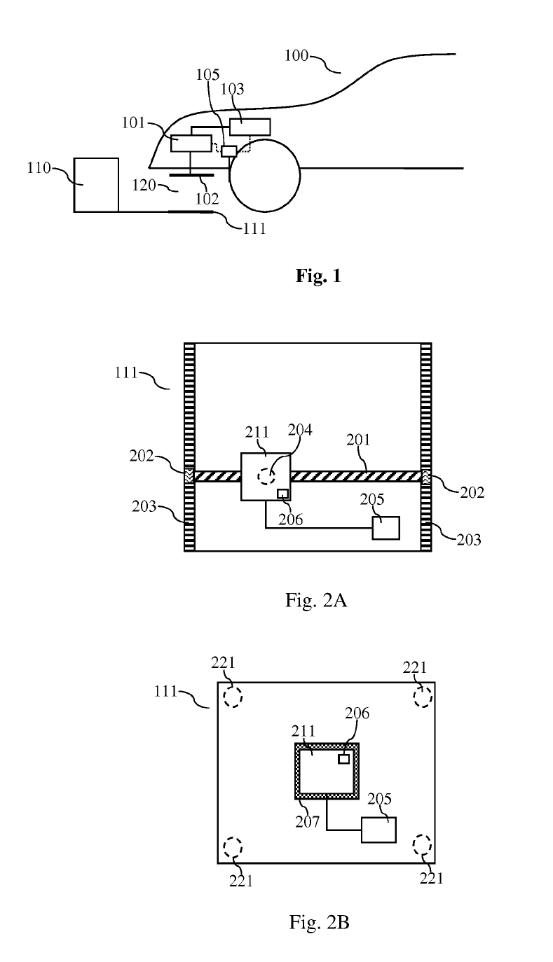

FIG. 2A shows the structure of a base unit 111 given by way of example. The base unit 111 includes a primary coil 211, which is arranged movably within a frame of the base unit 111. In particular, the primary coil 211 may be moved in up to two directions (x direction and y direction) in the horizontal plane. Furthermore, a rotating movement of the primary coil 211 may be provided. In the example shown, the base unit 111 includes two running rails 203, which make possible a movement of the primary coil 211 in a first direction (for example the y direction). Furthermore, the base unit 111 includes a transverse rail 201, by which a movement of the primary coil 211 in a second direction (for example the x direction) is made possible. The transverse rail 201 may be moved by way of wheels 202 (for example by way of gear wheels 202) on the running rails 203. The primary coil 211 may furthermore be arranged rotatably within the base unit 111 by way of a rotary joint 204.

The base unit 111 may include a control unit 205, which is designed to control the movement of the primary coil 211. In particular, suitable motors may be activated in order to move the primary coil 211 along the second direction on the transverse rail 201 and/or in order to move the primary coil 211 along the first direction on the running rails 203 and/or in order to rotate the primary coil 211 by way of the rotary joint 204.

The control unit 205 may be designed to determine one or more positioning signals, the one or more positioning signals providing items of information concerning how the primary coil 211 is positioned in relation to the secondary coil of the vehicle 100. For example, the one or more positioning signals may comprise:

(1) The signal strength of an electromagnetic field between the primary coil 211 and the secondary coil. For example, the secondary coil may generate an electromagnetic test field during the positioning operation. The primary coil 211 may receive this test field by way of inductive coupling. Furthermore, a signal strength of the received test field may be determined. The signal strength can be used to infer the degree of coupling between the primary coil 211 and the secondary coil, and consequently a relative positioning of the primary coil 211 and the secondary coil.

(2) Image data of a camera 206. As shown in FIG. 2A, the base unit 111 may include a camera 206, which is designed to sense image data of the underfloor of the vehicle 100. In particular, the camera 206 may be arranged on the movable primary coil 211. Furthermore, the camera 206 may be aligned upwardly in order to be able to sense the WPT vehicle unit 102 (and in particular the secondary coil).

The control unit 205 may be designed to move the primary coil 211 in dependence on the one or more positioning signals. In particular, the control unit 205 may be designed to move the primary coil 211 in such a way that a degree of coupling between the primary coil 211 and the secondary coil is increased (possibly maximized) and/or that an alignment of the primary coil 211 and an alignment of the secondary coil are made to match one another.

FIG. 2B shows a further structure by way of example of a base unit 111. The base unit 111 includes the primary coil 211, which is fixed on the base unit 111. Furthermore, the base unit 111 includes a multiplicity of rollers and/or wheels 221, by which a movement of the base unit 111 is made possible. In particular, the rollers and/or wheels 221 may be designed to make a movement of the base unit 111 possible in two directions (for example in the x direction and in the y direction) of the horizontal plane. Furthermore, a rotation of the base unit 111 may be made possible by the rollers and/or wheels 221. The control unit 205 may be designed to activate motors in order to move the base unit 111 by means of the rollers and/or wheels 221. In particular, for this purpose one or more positioning signals may be evaluated in order to make a precise positioning of the base unit 111 possible underneath the WPT vehicle unit 102 of the vehicle 100.

The base unit 111 in FIG. 2b further includes a lighting unit 207. The lighting unit 207 may be designed to emit light in the visible range, and thus display the position of the primary coil 211, and make it detectable for a camera (for example for a camera on the underfloor of the vehicle 100). The primary coil 211 shown in FIG. 2A may also include such a lighting unit 207. Alternatively or additionally, the WPT vehicle unit 102 may also include such a lighting unit 207 in order to make the position of the secondary coil detectable for the camera 206 of the base unit 111.

Consequently, this document describes a method and a corresponding device for inductively charging a vehicle 110 in which the inductive current-providing coil 211 or a part of this coil 211 is moved under the vehicle 100 by means of a controlling operation, so that an alignment of the current-providing coil 211 (i.e. the primary coil) in relation to the current-receiving coil (i.e. in relation to the secondary coil) is achieved. This has the advantage that the vehicle 100 if need be no longer has to be positioned precisely (in a manual or automatic way) over the base unit 111. Instead, the vehicle 100 can just be positioned relatively approximately by the driver. A precise positioning can then take place (automatically and/or manually) by a movement of the primary coil 211.

In this case, as shown for example in FIG. 2A, the current-providing coil 211 can be moved by way of an adjusting control 201, 202, 203, 204 within a fixed or installed frame. The current-providing coil 211 can then be moved in the x and y directions, for example by means of a worm drive 201, 202, 203. The rotation about the z axis may take place for example in a mounted manner (on ball-bearing balls 204) and/or by way of a gear drive. The adjusting controls and corresponding drives for the movement of the primary coil 211 can consequently be provided in a low-cost way.

Alternatively or additionally, the current-providing coil 211 or the base unit 111 may be provided with small wheels and/or rollers 221 and an electrical drive of its own, which are designed for the advancement of the coil 211 (for example directly on the floor of the garage). The primary coil 211 or the base unit 111 may move on the garage floor, for example on 4 small wheels 221. Such driven wheels/rollers 221 can be provided in a low-cost way. Delimiting markings, channels and/or a relief or one or more rails may possibly be provided on the floor in order if need be to delimit the radius of movement of the primary coil 211 or of the base unit 111. Such markings may alternatively or additionally be provided for the vehicle 100, in order at least to facilitate an approximate positioning of the vehicle 100 by the driver.

The current-providing (lower) coil 211 may as an alternative or in addition be designed with a camera 206, which generates and/or transmits a positioning signal with respect to the positioning of the current-providing coil 211 with respect to the current-receiving coil (i.e. the secondary coil). This may possibly be a wirelessly transmitted video image. The transmission of the image data may take place in particular wirelessly by WLAN to the vehicle 100 and/or to a device fitted in the vehicle and/or to a cell phone/smartphone of the driver and/or to a control unit 205 of the base unit 111.

Furthermore, a protective mechanism for the sensor, in particular camera, is described. This protective mechanism may be formed as an extendable part of the camera and/or as a protective device of the camera. The protective mechanism is designed to extend a part of the camera, for example the front lens, or to open a flap or shutter, when the approach of a vehicle to be charged is detected. This allows the possibly sensitive sensor to be protected better from environmental conditions. The image data of the secondary coil or the mounting thereof on the vehicle underfloor that is in this way recorded by the camera substantially from “underneath upward” allow the driver of the vehicle 100 to monitor the movement of the primary coil 211 under the vehicle 100. This advantage also applies whenever as an alternative or in addition to a movement of the primary coil 211 the vehicle 100 moves (automatically or manually by the customer). The positioning is consequently facilitated by the use of a camera 206.

The sensor may be designed in such a way that it can, at least for a time, sense the sensor data from the primary coil and from the secondary coil simultaneously. In this case, a simplified determination of the positioning data is possible. In this example, the sensor may be designed as a wide-angle camera.

The camera 206 of the primary coil 211 can be provided in a low-cost way (for example a smartphone camera with electronics and app capability and/or WLAN capability). A camera 206 with WLAN may be particularly advantageous and low in cost. The evaluation of the image data and following additional graphics may take place on a computing unit in the vehicle 100 and/or on an electronic device (for example a smartphone) of the driver and/or in the control unit 205 of the base unit 111.

Alternatively or additionally, a further sensor, in this example a video camera, which is directed downwardly, may be provided on the vehicle underfloor. Such a camera is however disadvantageous, since a vehicle camera can be contaminated relatively quickly. By contrast, the camera 206 proposed here, on the “lower”, current-providing coil 211, is exposed less to the environmental influences, and in addition also does not have to meet any automotive requirements and obtain certifications.

The lower coil 211 and/or the floor of the charging location (for example the base unit 111) may be provided with a lighting 207, in particular with one or more LEDs, in the visible spectrum and/or infrared spectrum, which may be designed for automatically switching on during the positioning operation. The light may for example be triggered as a sequence of light flashes. The times of the light flashes may be synchronized with the times of the recording by a camera 206. For example, a sequence may be of infrared flashes, which in particular make infrared-reflecting parts of the vehicle 100 easily detectable in the camera image.

The data transmitted from the charging device 110, 111 (i.e. from the lower current-providing coil 211 with the control unit 205) may include image data, which can be evaluated by use of image processing or object recognition.

In particular, the image data may be evaluated in order to determine a measure of the coincidence of the positions of the two coils in relation to one another. Alternatively or additionally, one or more parameters of the relative position may be determined. Alternatively or additionally, instructions or commands that can be used for correcting or optimizing the relative position may be determined. Such auxiliary data for the positioning may be generated for example by means of software in the vehicle 100, in a camera 206 and/or in an electronic device (for example smartphone).

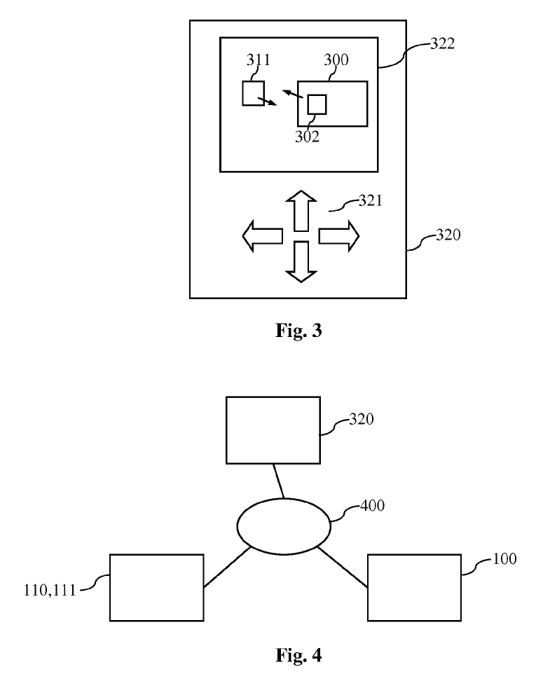

FIG. 3 shows an electronic device 320 given by way of example, for example a smartphone with a touch-sensitive screen. The electronic device 320 has an input unit 321 and an output unit 322. For example, interactive input elements for providing an input unit 321 may be displayed on a touch-sensitive screen. In the example shown, the input unit 321 comprises four cursors, with which an input with respect to a certain direction of movement can be sensed.

The output unit 322 may for example be a screen. The positioning of the base unit 111 and of the vehicle 100 may be graphically displayed on the output unit 322. In particular, an image 311 of the base unit 111 and an image 300 of the vehicle 100 and also an image 302 of the WPT vehicle unit 102 may be displayed. The displayed images 311, 300, 302 may for example be created on the basis of image data of one or more cameras 206.

The electronic device 320 may consequently be designed to display the positioning situation between the base unit 111 and the vehicle 100 on an output unit 322. Furthermore, the electronic device 320 may be designed to sense inputs by a user using the input unit 321. The inputs may be devised to move the base unit 111 and/or the vehicle 100. The electronic device 320 may be further designed to generate a control signal for the base unit 111 and/or for the vehicle 100 on the basis of a sensed input, a movement of the base unit 111 and/or of the vehicle 100 that corresponds to the sensed input being brought about by the control signal. The electronic device 320 may be further designed to send the control signal to the base unit 111 and/or the vehicle 100. This allows a movement of the base unit 111 and/or of the vehicle 100 to be remote-controlled by the electronic device 320. A movement brought about by the control signal can be displayed on the output unit 322 (as illustrated by the arrows shown in FIG. 3). This allows if need be a manual positioning between the base unit 111 and the vehicle 100 to be carried out by the electronic device 320, without a driver of the vehicle 100 having to return to the place where the vehicle 100 is parked.

The positioning operation can consequently be influenced/controlled by a user of the vehicle 100 using the graphic user interface of an electronic device 320 (for example of a smartphone and/or of a display in the vehicle 100). The electronic device 320 (or the operating software running on the electronic device 320) may be designed in such a way that the user only has to specify the resultant direction of movement of the base unit 111 and/or of the vehicle 100, while the trajectory is determined automatically as a compilation of individual movements of the base unit 111 and/or of the vehicle 100. For this purpose, the graphic interface may include an actual object recorded and/or detected by a sensor (for example by a camera 206). In this case, detected objects (for example the base unit 111 and/or the vehicle 100) may be represented by virtual formations/images 311, 300, for example by a special design of an augmentation.

A user of the electronic device 320 can thus see the movement of the current-providing coil 211 or of the base unit 111 under his/her vehicle 100 (actually or at least partially symbolically displayed) and can influence this movement within the same output unit 322 (i.e. within the same screen) and/or by way of an input unit 321 (for example by way of a rotary knob).

In a preferred design variant, the current-providing coil 211 or parts of this coil 211 is/are designed to set the optimum position with respect to the secondary coil substantially automatically. The user can see, and at the same time possibly also influence, for example speed up, correct, stop, direct, etc., the movement of the coil 211 on a screen 322. The monitoring or control of the positioning operation may preferably take place by way of a graphic display or by way of a graphic interface (operating symbols, such as for example arrows) and/or by way of the rotation of the electronic device 320, which can be interpreted by way of its own sensor system as a movement request.

The provision of the remote monitoring and/or remote control described above may also be realized with the aid of an app, which runs on the on-board computer of the vehicle 100 and/or on a smartphone. In particular, at least part of the operating software may run in a computer unit of the vehicle 100.

The vehicle 100 may include a substantially downwardly aligned sensor, which is designed for the purpose of monitoring the relative position between the primary coil 211 and the secondary coil. In particular, a visualization may be displayed here in the form of a “synthetic image”, created artificially by data of the sensor conditioned by image or signal processing means, on a display of the vehicle 100 and/or on a computer and/or on a smartphone 320 of the user. This may preferably be an infrared LED sensor. The sensor may be designed like a position-sensing unit similar to a computer mouse. The data provided by the sensor may be taken into account as positioning signals in the positioning of the primary coil 211 and/or of the vehicle 100.

The adjusting control (i.e. in particular the control unit 205) of the base unit 111, which is used for the positioning of the current-providing coil 211, may receive a signal transmitted wirelessly (for example by WLAN) from the vehicle 100, with items of information concerning the already achieved positioning quality or concerning positioning parameters. This allows a control circuit to be closed in order to control the positioning operation. The transmitted signal may be used as a manipulated variable or as an input for determining a manipulated variable of the movement actuators of the base unit 111.

The control unit 205 may consequently use a control loop in order to position the primary coil 211. The control in this case typically controls the coil position until the predetermined geometrical parameters and/or the predetermined deviation from the maximum possible induction quality and/or the maximum inductive coupling or the adaptation of the optimum energy transfer efficiency is achieved.

The use of a control circuit, which possibly also takes into account feedback messages from the vehicle 100, makes it possible to monitor, and possibly maximize, directly the degree of coupling to be achieved. This allows the energy efficiency of the vehicle charging to be improved decisively. Such an optimum typically cannot be achieved by an only relatively approximate positioning of the vehicle over the primary coil 211.

The control unit 205 may be designed to send a signal concerning a successful and/or unsuccessful positioning wirelessly to an electronic device 320 (for example to a cell phone) of a user and/or to the home network of the user. This may obviate the need for monitoring the positioning operation.

As already explained above, a movement of the primary coil 211 may also be used in combination with an automatically positionable vehicle. For example, the vehicle 100 may be designed to position itself automatically (relatively approximately) in the vicinity of the base unit 111. The movement of the current-providing coil 211 then allows a precise and quick fine positioning to take place (for example by a rotation of the primary coil 211). This allows movements which, for the vehicle 100, can only be carried out with difficulty (for example rotations) to be carried out in an easy and quick way by the primary coil 211. This allows the time expenditure for a driver of the vehicle 100 to be reduced substantially.

A movement of the vehicle 100 and a movement of the primary coil 211 can be made to match one another. In particular, an overall requirement for relative movement or a deviation from a target position (X, Y, Z, rotation) can be determined for example by the control unit 205, in order to achieve a precise positioning. This overall requirement, i.e. this overall movement, may then be divided into vehicle movement components, which can be carried out by the vehicle 100, and into coil movement components, which can be carried out by the primary coil 211. This allows the positioning operation to be speeded up further. The efficiency of the positioning operation can also be increased.

FIG. 4 shows a system including a vehicle 100, a charging station 110, 111 and an electronic device 320, which can communicate with one another by way of a network 400, in order to exchange data with respect to the positioning of the primary coil 211 and of the secondary coil. The methods described in this document can be implemented by the vehicle 100, the charging station 110, 111 and/or the electronic device 320 in any desired combination.

It is pointed out in particular that the methods described in this document can be performed for example by a dedicated system, which is for example arranged at the charging station 110, 111. Furthermore, the vehicle 100 may be designed to perform the methods described in this document. An electronic device 320 (for example a smartphone or a cell phone) may also be designed to perform the methods described in this document.

The methods described in this document have a large number of advantages: risks and damages for a driver of a vehicle (for example damages to property and personal injuries) that could arise in the case of an automatically moved vehicle are avoided. Possibly high requirements for vehicle-based solutions (ASIL development with the requisite functional safety) are avoided. There are no longer complex technical dependences on vehicle systems. In particular, there are no longer numerous requirements for special equipment and the architecture of a vehicle, resulting in cost advantages. There are no backward compatibility restrictions. In particular, a vehicle-external solution typically has increased flexibility, since the charging device can also be further developed independently of the development process of a vehicle. Consequently, substantial reductions of the development time and development costs of vehicles are obtained. The solution described in this document is also quite acceptable for public areas. In particular, the ability to obtain approval is facilitated in various ways, since the system is independent of the Vienna Convention, of homologation procedures, etc. The method described in this document allows the time expenditure for the positioning of the coils to be reduced. The preparation for the charging operation can proceed more quickly. Furthermore, no laborious maneuvering operations by a driver are required. The use of smaller parking spaces/garages is also made possible, since the primary coil can be moved more flexibly than a vehicle. Furthermore, increased user friendliness can be provided by the user interface described.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A base unit for a charging station for inductively charging an energy store of a vehicle, the base unit comprising:
a primary coil, which is designed to transfer electrical energy to a secondary coil of the vehicle when there is an electromagnetic coupling with the secondary coil;
a sensor, which is designed to sense sensor data from at least a part of the vehicle; and
a control unit, which is designed to provide or use the sensor data for a positioning of the secondary coil in relation to the primary coil.

2. The base unit as claimed in claim 1, wherein
the sensor is designed for sensing a machine-readable code.

3. The base unit as claimed in claim 2, wherein the machine-readable code comprises one or more of the following data:
one or more optimized charging curves,
one or more items of frequency information relating to the charging operation,
an item of information that represents the position of the secondary coil within the vehicle underfloor, and/or
one or more geometrical parameters that represent the arrangement of the secondary coil within the vehicle.

4. The base unit as claimed in claim 1, wherein
the sensor is designed to sense image data with respect to an underfloor of the vehicle.

5. The base unit as claimed in claim 1, wherein
the sensor is connected to the primary coil; and/or
the sensor is moved in a way dependent on the movement of the primary coil.

6. The base unit as claimed in claim 1, wherein
the base unit is designed to evaluate image data of an image series or an image sequence, in order to determine a position of the primary coil in relation to the secondary coil via image processing or object recognition.

7. The base unit as claimed in claim 1, wherein
the sensor is designed for detecting a predetermined part of the vehicle.

8. The base unit as claimed in claim 1, wherein
the sensor is designed for detecting at least two or more parts of the vehicle and for determining the position and/or the angle in relation to at least two or more of the detected parts.

9. The base unit as claimed in claim 1, wherein
the base unit is designed to determine on the basis of image data information with respect to a technical parameter of the vehicle.

10. The base unit as claimed in claim 1, further comprising:
movement devices which are designed to move the primary coil in order to bring about an electromagnetic coupling between the primary coil and the secondary coil.

11. The base unit as claimed in claim 10, wherein
the base unit comprises a frame;
the movement devices comprise one or more rails, which are connected to the frame; and
the movement devices further comprise actuators, which are designed to move the primary coil along the one or more rails.

12. The base unit as claimed in claim 11, wherein
the movement devices further comprise rotation devices, which are designed to rotate the primary coil about a vertical axis of the primary coil.

13. The base unit as claimed in claim 10, wherein
the movement devices comprise one or more wheels and/or rollers, which are designed to move the primary coil.

14. The base unit as claimed in claim 4, wherein
the base unit comprises lighting, which is designed to generate a light pattern and/or one or more light pulses; and
the sensor is designed to sense a reflection of the light pattern and/or of the one or more light pulses on the underfloor of the vehicle.

15. The base unit as claimed in claim 7, wherein the predetermined part of the vehicle is one of the secondary coil, part of vehicle tires, or part of vehicle axles.

16. The base unit according to claim 9, wherein the technical parameter of the vehicle is with respect to the secondary coil or the energy store of the vehicle.

17. A method for positioning a primary coil of a base unit under a secondary coil of a vehicle, the method comprising the acts of:
determining sensor data by a sensor of the base unit, wherein the sensor data comprise items of information relating to the position of at least a part of the vehicle; and
changing the position of the primary coil and/or of the secondary coil in dependence on the sensor data.

18. A method for positioning a secondary coil of a vehicle in relation to a primary coil of a base unit, wherein the position of the secondary coil of the vehicle is changeable by an activation of an actuator of the vehicle, the method comprising the acts of:
determining positioning signals from sensor data of a sensor that is connected to the base unit;
transmitting the positioning signals to the vehicle; and
activating the actuator of the vehicle in dependence on the transmitted positioning signals in order to bring about an electromagnetic coupling between the primary coil and the secondary coil for inductively charging an energy store of the vehicle.

19. A computer program product, comprising a non-transitory computer readbale medium having stored thereon program code that, when executed by a processor, carries out the method of claim 17.

20. A computer program product, comprising a non-transitory computer readbale medium having stored thereon program code that, when executed by a processor, carries out the method of claim 18.
